(19) United States
(12) Patent Application Publication
(10) Pub. No.: US 2002/0071067 A1
(43) Pub. Date: Jun. 13, 2002

(54) Backlight and liquid crystal display apparatus using the same

(76) Inventor: Ryuichi Yoshitoshi, Kawagoe-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/903,873

(22) Filed: Jul. 13, 2001

(30) Foreign Application Priority Data
Dec. 13, 2000 (JP) 2000-379182

(51) Int. Cl. G02F 1/1335

(52) U.S. Cl. 349/65

(57) ABSTRACT

A backlight for liquid crystal panel, wherein a light source, a light guide plate provided with the light source at least on one end face, and a light diffusion sheet provided on a front face of the light guide plate are housed in a case, and a back surface of the light guide plate and a bottom surface of the case are closely adhered. A prism step surface made by offset curves having a predetermined width by setting the light source as the center is formed on the back surface of the light guide plate.

### BACKGROUND OF THE INVENTION

1. Field of the Invention

The present invention relates to a backlight preferably to be used for a transmission type liquid crystal display apparatus, particularly relates to a low cost backlight having high luminance and a preferable luminance distribution.

2. Description of the Related Art

Transmission type liquid crystal display apparatus is provided with a backlight, and the backlights of this kind can be divided to a directly behind type to arrange a light source directly behind a liquid crystal panel and an edge type to arrange a light source at an edge portion (side portion) of a liquid crystal panel.

As an edge type backlight of the related art, for example, there is known the one disclosed in the Japanese Examined Patent Publication No. 7-113718. To briefly explain with reference to FIG. 6, the backlight comprises a lamp 17 positioned beneath an edge portion of a liquid crystal panel 11, an acrylic light guide plate 15 arranged on one end surface of the lamp 17, a reflection sheet 18 having a high reflection rate arranged on the back surface of the light guide plate 15 and between the same and a case 16 and a light diffusion sheet 13 arranged on the surface of the light guide plate 15. Consequently, a light emitted from the lamp 17 irradiates from one end surface of the light guide plate 15 and proceeds to the light diffusion sheet 13, while a part of the light is reflected on the reflection sheet 18 and proceeds to the light diffusion sheet 13. Then, the light having become more uniform by the light diffusion sheet 13 brings the liquid crystal panel 11 to illuminate with light.

However, the above explained edge type backlight of the related light requires the reflection sheet 18 for reflecting the light from the lamp 17 to the liquid crystal panel 11 side, and thereby, becomes costly.

### SUMMARY OF THE INVENTION

An object of the present invention is to provide a backlight which does not need a reflection sheet while preferably maintaining high luminance and a luminance distribution.

(1) To attain the above object, according to a first aspect of the present invention, there is provided a backlight for liquid crystal panel, wherein a light source, a light guide plate provided with the light source at least on one end face, and a light diffusion sheet provided on a front face of the light guide plate are housed in a case, and a back surface of the light guide plate and a bottom surface of the case are closely adhered.

Also, according to a second aspect of the present invention, there is provided a backlight for liquid crystal panel, wherein a light source, a light guide plate provided with the light source at least on one end face, and a light diffusion sheet provided on a front face of the light guide plate are housed in a case, and a back face of the light guide plate is formed a prism stage surface made by offset curves having a predetermined width by setting the light source as the center.

Furthermore, according to a third aspect of the present invention, there is provided a backlight for liquid crystal wherein a light source, a light guide plate provided with the light source at least on one end face are housed in a case, and the light guide plate contains a light diffusion material.

In the above invention, it is more preferable that the above light guide plate and case are formed to be one body by a two color molding method or an insert molding method.

Alternately, instead of the above, the above light guide plate and case are more preferably formed to be one body by injection molding by which a material constituting the light guide plate is injected to a molded case.

Furthermore, in the above invention, the above light guide plate preferably contains a coloring agent for luminance adjustment.

The above backlight can be applied to a liquid crystal display apparatus.

(2) In the backlight according to the first aspect of the present invention, the back surface of the light guide plate and the bottom surface of the case are closely adhered. The close adherence here means an extent that there is no air layer generated between the back surface of the light guide plate and the bottom surface of the case. By doing so, sufficient luminance can be obtained without providing a reflection sheet on the back surface of the light guide plate and the luminance distribution becomes uniform. Namely, the reflection sheet can be omitted while maintaining luminance characteristics, so the cost can be reduced.

In the backlight according to the second aspect of the present invention, a prism step surface made by offset curves having a predetermined width wherein a light source is the center is formed on the back surface of the light guide plate. The step surface made by offset curves indicates that the width of mutually adjacent step different surfaces are substantially equal in its whole periphery. It means, for example, “t” is constant in an example shown in FIG. 4. By forming a prism step surface made by offset curves having a predetermined width as such, the light emitted from the light source and irradiates from one end surface to the light guide plate is reflected respectively on the prism step surface, consequently, a uniform light is to be emitted from the surface of the light guide face to the light diffusion sheet and the luminance distribution remarkably improves.

Furthermore, in the backlight according to the third aspect of the present invention, a light guide plate containing a light diffusion agent is used, so sufficient luminance and preferable luminance distribution can be obtained only by a light guide plate, and the light diffusion sheet normally provided on the front face of the light guide plate can be omitted.

Note that to adjust chromaticity and unevenness of the light source, it is preferable to add to a light guide plate a coloring agent to color it to white, blue, etc. in the same way as in the case of using a light emitting diode (LED) as a light source.

### BRIEF DESCRIPTION OF THE DRAWINGS

These and other objects and features of the present invention will be explained in more detail below with reference to the attached drawings, wherein:

FIG. 1 is a disassembled perspective view of a liquid crystal display apparatus using a backlight according to an embodiment of the present invention;

FIG. 2 is a perspective view of the liquid crystal display apparatus (assembled state) in FIG. 1;

FIG. 3 is a sectional view along the line III-III in FIG. 2;

FIG. 4 is a plan view of a case of an example of offset curves according to the present invention;

FIG. 5A is a luminance distribution of an embodiment, and FIG. 5B is a view of a luminance distribution of a comparative example; and

FIG. 6 is a sectional view of a backlight of the related art.

### DESCRIPTION OF THE PREFERRED EMBODIMENTS

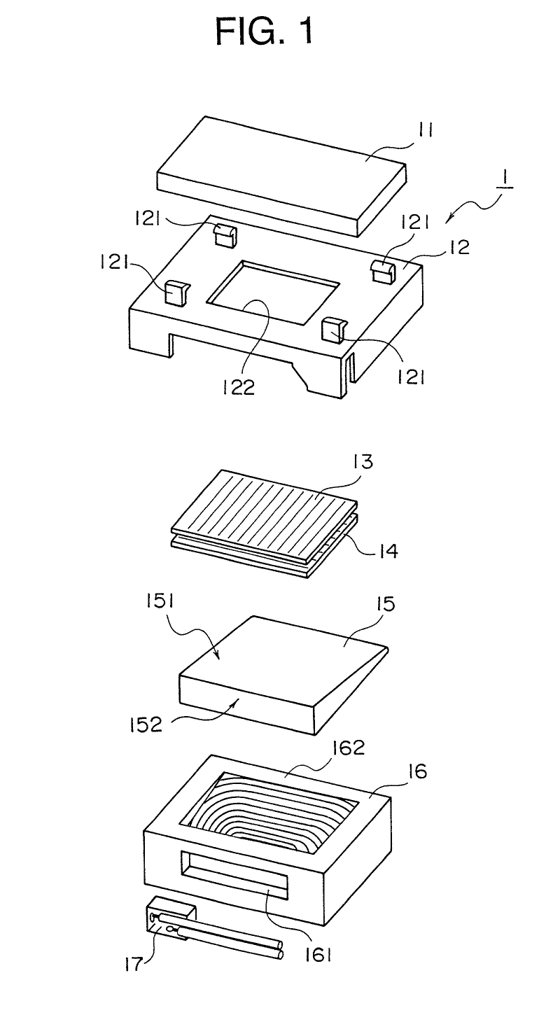

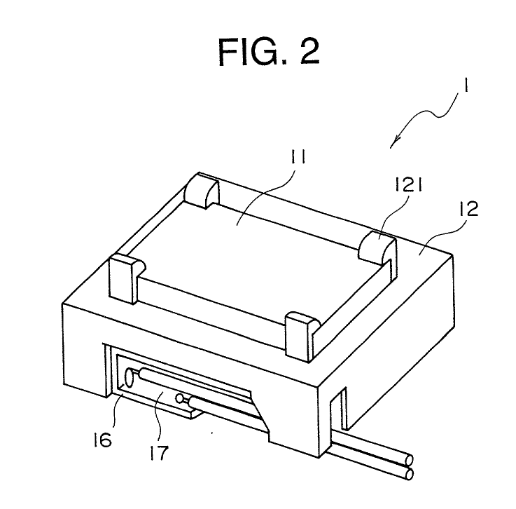

A liquid crystal display apparatus 1 of the present example comprises, as shown in FIG. 1 and FIG. 2, a liquid crystal panel 11, a first case 12, light diffusion sheets 13 and 14, a light guide plate 15, a second case 16 and a light source 17.

The liquid crystal panel 11 is a light transmission type liquid crystal panel, which is attached to the first case 12 by four hooks 121 formed on an upper surface of the first case 12. A diffused light from a later explained light source 17 passes through an opening 122 formed on the first case 12, so that the light is irradiated on the back face of the liquid crystal panel 11.

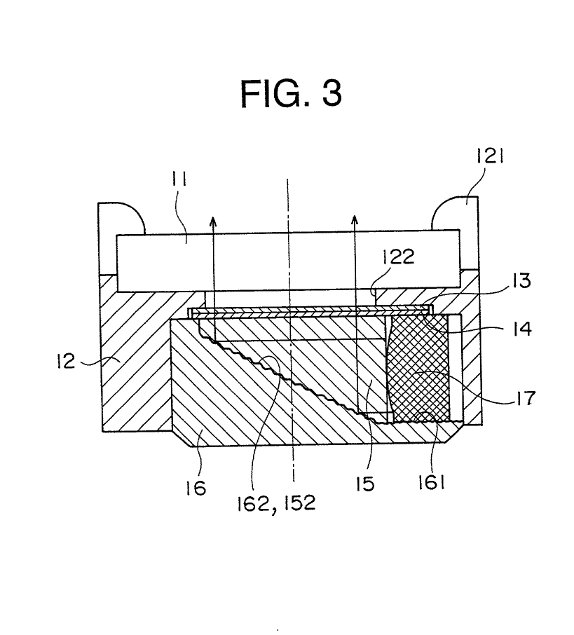

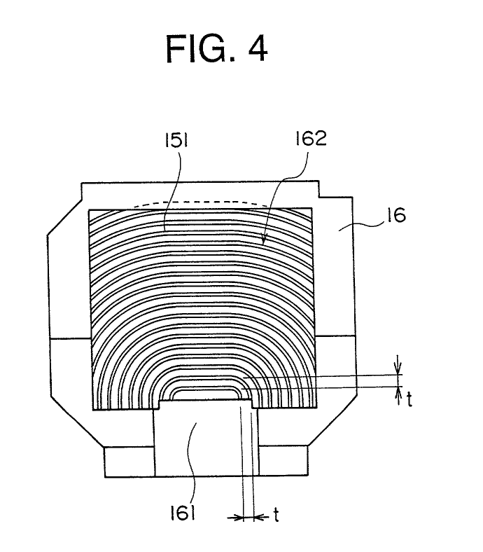

The second case 16 shown on the lower part of the same figure is mainly for supporting the light guide plate 15 and the light source 17 and is formed an opening 161 for setting the light source 17 and a slope 162 continuing to the opening 161. FIG. 3 shows a sectional view along the line III-III in FIG. 2, and FIG. 4 is a plan view of the second case 16 of an example of offset curves according to the present invention.

A surface 151 (the liquid crystal panel side) of the light guide plate 15 is made to be flat, and a back surface 152 thereof is made to be a slope corresponding to the slope 162 of the second case 16 so that the two can closely adhered.

The light diffusion sheets 13 and 14 are sheets for diffusing the light from the light source 17 passed through the light guide plate 15 to be uniform and irradiating the light on the back surface of the liquid crystal panel 11. In the present example, two sheets 13 and 14 whose diffusion faces are orthogonal to each other are superimposed.

Particularly, in the present embodiment, the back face 152 of the light guide plate 15 is formed a step surface 153 made by offset curves shown in FIG. 4, and the slope 162 of the second case 16 is formed a step surface made by the same offset curves so as to be closely adhered to the back surface 152 of the light guide plate 15. Actually, the light guide plate 15 and the second case 16 are formed to be one body by two color molding or injection molding, as a result, a back face 152 of the light guide plate 15 and the slope 162 of the second case 16 are formed a step surface made by the offset curve, and the back face 152 of the light guide plate 15 and the slope 162 of the second case 16 are closely adhered. A production method thereof will be explained later on.

The step surface (hereinafter, the reference number 152 will be put on) made by offset curves of the present example is, as shown in FIG. 4, a step surface having a radius which becomes gradually larger while keeping a certain distance “t” by setting the opening 161, to which the light source 17 is set, as the center.

Note that the first case 12 and the second case 16 are comprised of a coloring resin, such as polycarbonate (hereinafter, simply referred to as PC), or a transparent resin, and the light guide plate 15 is comprised of a resin having excellent optical characteristics, such as polymethacrylate (hereinafter, also simply referred to as PMMA) and polycarbonate.

The liquid crystal display apparatus 1 of the present example can be assembled by forming the light guide plate 15 and the second case 16 to be one, then setting a light source 17 to the same, and inserting what obtained by setting the light diffusion sheets 13 and 14 to the surface 151 of the light guide plate 15 from below the first case 12. The liquid crystal panel 11 is set to the hooks 121 on the upper surface of the first case 12.

To make the light guide plate 15 and the second case 16 to be one body (closely adhered), a method of separately forming the second case 16 made by PC and the light guide plate 15 made by PMMA by injection molding or extrusion molding and adhering the results by adhesive, etc. and also a method of forming the second case 16 made by PC and the light guide plate 15 made by PMMA by two color molding, and a method of forming the light guide plate 15 by injection molding (potting molding) of gel silicone polymethyl methacrylate (Si-PMMA) and hardening at the room temperature can be applied. Particularly, when the light guide plate 15 and the second case 16 are made to be one body by the latter two color molding and potting molding, the joining surfaces of the both 15 and 16 are completely adhered, so the reflection efficiency of the light from the light source 17 is further improved.

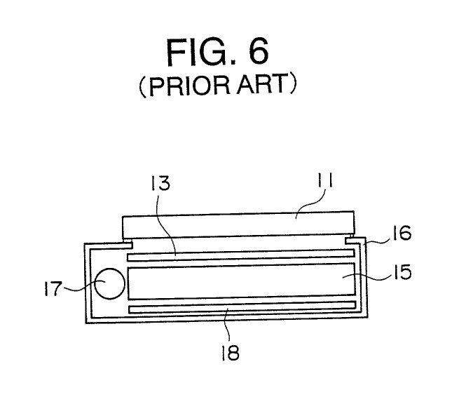

As explained above, in the liquid crystal display apparatus 1 of the present example, by closely adhering the back surface 152 of the light guide plate 15 and the slope 162 of the second case 16, the reflection efficiency of the light from the light source 17 is improved and a light having a sufficient light amount can be supplied to the liquid crystal panel 11 even when not provided with a reflection sheet (refer to the reference number 18 in FIG. 6). Accordingly, the cost can be reduced in an amount of omitting the reflection sheet.

Also, in the liquid crystal display apparatus 1 of the present example, since the step surface 152 made by offset curves having a predetermined width by setting the light source 17 as the center is formed on the back face 152 of the light guide plate 15 (and on the slope 162 of the second case 16), light at the lower portion in the light emitted from the light source 17 and irradiated into the light guide plate 15 is reflected by the step surface on the light source side (on the right side in FIG. 3), and guided to the left side on the back surface of the liquid crystal panel 11. Such light diffusion is made in a offset curves shape of even intervals by setting the light source 17 as the center, so uniformity of luminance of the light emitted on the back face of the liquid crystal panel 11 is widely improved comparing with the case of configuring the back face 152 of the light guide plate 15 by a simple flat slope.

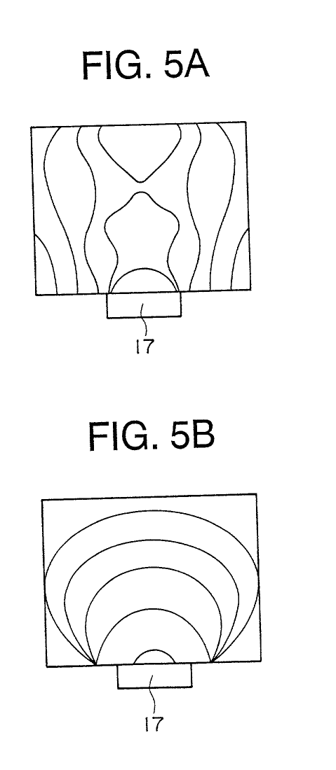

FIG. 5(A) is a view of a luminance distribution when using a light guide plate 15 having the step surface 152 made by offset curves of the present invention, and FIG. 5(B) is a view of a luminance distribution when using a light guide plate without the step surface. As is obvious from the figures, the one being formed the step surface 152 of the present invention has excellent uniformity in the luminance distribution. When using a light emitting diode as the light source 17, unevenness of the comparison example without the step surface shown in FIG. 5(B) was 70%, while in the case of being provided with the step surface 152 made by offset curves in the embodiment of the present invention, the unevenness of the luminance could be reduced to 10%.

Note that the embodiments explained above were described to facilitate the understanding of the present invention and not to limit the present invention. Accordingly, elements disclosed in the above embodiments include all design modifications and equivalents belonging to the technical field of the present invention.

For example, a cold cathode tube can be used as the above light source 17, and when using a light emitting diode LED as the light source 17, the light guide plate 15 may be colored to be semitransparent white or blue, etc. for adjusting the chromaticity of the light emitting diode.

Also, a light guide plate 15 containing a light diffusion material may be used. As the light diffusion material here, for example when the light guide plate 15 is formed by PMMA or PC material, (a) silicone resin fine particles having an average grain diameter of 1 to 6 μm and non-organic transparent material particles (for example, barium sulfate, calcium carbonate, etc.), (b) non-organic fine particles, such as barium sulfate, calcium carbonate, of 10 μm or less, (c) non-organic transparent material particles, such as glass particles, quartz glass particles, calcium fluoride, of 1 to 10 μm or organic transparent material particles, such as polyethylene, polymethacrylate, fluoride of acrylic ester, of 1 to 10 μm, (d) transparent fine particles, such as silica, glass, calcium fluoride, aluminum hydroxide, of 3 to 50 μm, etc. can be mentioned, and these particles are dispersed in a PMMA resin or PC resin. When using the light guide plate containing the thus obtained light diffusion agent, the light guide plate itself exhibits sufficient luminance and a preferable luminance distribution, so the light diffusion sheets 13 and 14 can be omitted in the example shown in FIG. 1.

1. A backlight for liquid crystal panel, wherein a light source, a light guide plate provided with said light source at least on one end face, and a light diffusion sheet provided on a front face of said light guide plate are housed in a case, and a back surface of said light guide plate and a bottom surface of said case are closely adhered.

2. A backlight for liquid crystal panel, wherein a light source, a light guide plate provided with said light source at least on one end face, and a light diffusion sheet provided on a front face of said light guide plate are housed in a case, and a back face of said light guide plate is formed a prism step surface made by offset curves having a predetermined width by setting said light source as the center.

3. A backlight for liquid crystal wherein a light source, a light guide plate provided with said light source at least on one end face are housed in a case, and said light guide plate contains a light diffusion material.

4. A backlight as set forth in claim 1, wherein said light guide plate and said case are formed to be one body by a two color molding method.

5. A backlight as set forth in claim 2, wherein said light guide plate and said case are formed to be one body by a two color molding method.

6. A backlight as set forth in claim 3, wherein said light guide plate and said case are formed to be one body by a two color molding method.

7. A backlight as set forth in claim 1, wherein said light guide plate and said case are made to be one body by an injection molding wherein a material constituting the light guide plate is injected to a molded case.

8. A backlight as set forth in claim 2, wherein said light guide plate and said case are made to be one body by an injection molding wherein a material constituting the light guide plate is injected to a molded case.

9. A backlight as set forth in claim 3, wherein said light guide plate and said case are made to be one body by an injection molding wherein a material constituting the light guide plate is injected to a molded case.

10. A backlight as set forth in claim 1, wherein said light guide plate contains a coloring agent for luminance adjustment.

11. A backlight as set forth in claim 2, wherein said light guide plate contains a coloring agent for luminance adjustment.

12. A backlight as set forth in claim 3, wherein said light guide plate contains a coloring agent for luminance adjustment.

13. A liquid crystal display apparatus comprising the backlight as set forth in claim 1.

14. A liquid crystal display apparatus comprising the backlight as set forth in claim 2.

15. A liquid crystal display apparatus comprising the backlight as set forth in claim 3.
